(19) United States
(12) Patent Application Publication
(10) Pub. No.: US 2002/0188850 A1
(43) Pub. Date: Dec. 12, 2002

(54) Method for accelerated transmission of electronic signature

(76) Inventors: David Naccache, Paris (FR); Jean-Sebastien Coron, Paris (FR)

Correspondence Address: BURNS DOANE SWECKER & MATHIS L L P, POST OFFICE BOX 1404, ALEXANDRIA, VA, 22313-1404, US

(21) Appl. No.: 10/148,022

(22) PCT Filed: Sep. 26, 2001
(86) PCT No.: PCT/FR01/02984

(30) Foreign Application Priority Data
Sep. 28, 2000 (FR) 00/12352

(51) Int. Cl. G06F 12/14; G06F 11/30; H04L 9/32; H04L 9/00

(52) U.S. Cl. 713/176; 713/200

(57) ABSTRACT

The RSA enciphering algorithm is the most widely used public key enciphering algorithm. The invention consists of defining a method for considerably reducing the size of the signatures to be transmitted. The invention can be used easily in an electronic component of the smart card type.

The present invention concerns a method for the accelerated transmission of an electronic signature of the public key electronic signature type.

In the conventional model of secret key cryptography, two persons wishing to communicate by means of a non-secure channel must first agree on a secret enciphering key K. The enciphering function and the deciphering function use the same key K. The drawback of the secret key enciphering system is that the said system requires the prior communication of the key K between the two persons by means of a secure channel, before any enciphered message is sent through the non-secure channel. In practice, it is generally difficult to find a perfectly secure communication channel, especially if the distance separating the two persons is great. Secure channel means a channel for which it is impossible to know or modify the information passing over the said channel. Such a secure channel can be implemented by a cable connecting two terminals possessed by the said two persons.

The concept of public key cryptography was invented by Whitfield Diffie and Martin Hellman in 1976. Public key cryptography resolves the problem of the distribution of the keys through a non-secure channel. The principle of public key cryptography consists of using a pair of keys, a public enciphering key and a private deciphering key. It must be unfeasible from the computing point of view to find the private deciphering key from the public enciphering key. A person A wishing to communicate information to a person B uses the public enciphering key of the person B. Only the person B possesses the private key associated with his public key. Only the person B is therefore capable of deciphering the message which is sent to him.

Another advantage of public key cryptography over secret key cryptography is that public key cryptography allows authentication by the use of an electronic signature.

The first embodiment of a public key enciphering scheme was developed in 1977 by Rivest, Shamir and Adleman, who invented the RSA enciphering system. RSA security is based on the difficulty of factorising a large number which is the product of two prime numbers. Since then, many public key enciphering systems have been proposed, whose security is based on various computing problems (this list is not exhaustive):

Merkle-Hellman “knapsack”:

This enciphering system is based on the difficulty of the problem of the sum of subsets;

McEliece:

This enciphering system is based on the theory of algebraic codes. It is based on the problem of the decoding of linear codes;

ElGamal:

This enciphering system is based on the difficulty of the discrete logarithm in a finite field;

Elliptic curves:

The elliptic curve enciphering system constitutes a modification of existing cryptographic systems in order to apply them to the field of elliptic curves. The advantage of elliptic curve enciphering systems is that they require a smaller size of key than for the other enciphering systems.

The RSA enciphering system is the most widely used public key enciphering system. It can be used as an enciphering method or as a signature method. The RSA enciphering system is used in smart cards, for certain applications thereof. The possible applications of RSA to a smart card are access to data banks, banking applications, remote payment applications such as for example pay television, petrol dispensing or the payment of motorway tolls.

The principle of the RSA enciphering system is as follows. It can be divided into three distinct parts, namely:

1) The generation of the pair of RSA keys;

2) The enciphering of a message in clear into an enciphered message, and

3) The deciphering of an enciphered message into a message in clear.

The first part is the generation of the RSA key. Each user creates an RSA public key and a corresponding private key, in accordance with the following method in 5 steps:

4) Generating two distinct prime numbers p and q of the same size;

5) Calculating n=pq and φ=(p−1)(q−1)

6) Randomly selecting an integer e, 1<e<φ, such that pgcd(e, φ)=1;

7) Calculating the unique integer d, 1<d<φ, such that e*d=1 mod φ;

8) The public key is (n,e); the private key is d or (d,p,q).

The integers e and d are called respectively the enciphering exponent and the deciphering exponent. The integer n is called the modulus.

The second part consists of the enciphering of a message in clear denoted m by means of an algorithm with 1<m<n into an enciphered message denoted c, which is as follows:

Calculating c=mˆ e mod n.

The third part consists of the deciphering of an enciphered message using the private deciphering exponent d by means of an algorithm. The algorithm for deciphering an enciphered message denoted c with 1<c<n into a message in clear denoted m is as follows:

Calculate m=cˆ d mod n.

The RSA system can also be used for generating electronic signatures. The principle of an electronic signature scheme based on the RSA system can generally be defined in three parts:

The first part being the generation of the RSA key, using the method described in the first part of the RSA system described previously;

The second part being the generation of the signature. The method consists of taking as an input the message M to be signed, applying to it an encoding using a function μ in order to obtain the character string μ(M), and applying the deciphering method of the third part of the RSA system described above. Thus only the person possessing the private key can generate the signature;

The third part being the verification of the signature. The method consists of taking as an input the message M to be signed and the signature s to be verified, applying an encoding to the message M using a function μ in order to obtain the character string μ(M), applying to the signature s the enciphering method described in the second part of the RSA system, and verifying that the result obtained is equal to μ(M). In this case, the signature s of the message M is valid, and in the contrary case it is false.

There are many encoding methods using different functions μ. One example of an encoding method is the method described in the standard “ISO/IEC 9796-2, Information Technology—Security techniques—Digital signature scheme giving message recovery, Part 2: Mechanisms using a hash-function, 1997”. Another example of the encoding method is the encoding method described in the standard “RSA Laboratories, PKCS#1: RSA cryptography specifications, version 2.0, September 1998”. These two encoding methods make it possible to sign messages of arbitrarily long size.

The drawback of the two encoding methods cited above is that they require the transmission of an electronic signature of the size of the RSA modulus, that is to say typically 1024 bits. For some applications of the electronic signature methods, it happens that the private key of the user is known to the entity verifying the signature, in particular when this entity is a certification authority or a bank.

The method of the invention consists of transmitting only part S′ of the signature S of a message M. The method of the invention consists of two distinct parts, the first being the generation of the short signature, the second being the verification of the short signature by the entity having the private key of the user.

The method of generating the short signature takes as an input a message M and the private key d of the user, and comprises the following steps:

1) Generating the signature S of the message M using the private key d of the user.

2) Calculating part S′ of the signature S, the said part being able to be a string of bits included in the signature S.

The method of verifying the short signature takes as an input a message M, the short signature S′ to be verified and the private key d of the user, and comprises the following steps:

1) Generating the signature S of the message M using the private key d of the user.

2) Calculating part S″ of the signature S, and verifying that the part S″ is equal to the short signature S′.

The advantage of the short signature generation and verification method is that the size of the signature to be transmitted is much smaller than in the general case: it is thus possible to transmit only 64 bits of the signature instead of 1024 bits. The result is better performance due to lower transmission times.

1. An electronic signature method consisting of transmitting only part S′ of the signature S of a message M, characterised in that it comprises two distinct parts, the first being the generation of the short signature, the second being the verification of the short signature by the entity having the private key of the user.

2. A method according to claim 1, characterised in that the generation of the short signature comprises the following 2 steps:
1) Generating the signature S of the message M using the private key d of the user.
2) Calculating part S′ of the signature S.

3. A method according to claim 1, characterised in that the verification of the signature S of the message M using the private key d of the user comprises the following 2 steps:
1) Generating the signature S of the message M using the private key d of the user;
2) Calculating part S″ of the signature S, and verifying that the part S″ is equal to the short signature S′.

4) A method according to either one of claims 2 or 3, characterised in that the parts S′ and S″ of the signature S are a string of bits included in the signature S.

5) A method according to any one of the preceding claims, characterised in that the signature system used is based on the RSA system.

6) A method according to claim 1, characterised in that the entity verifying the signature is a bank.

7) A method according to claim 1, characterised in that the entity verifying the signature is a certification authority.

8) A method according to any one of the preceding claims, characterised in that it uses a portable object of the smart card type.
